(19) United States
(12) Patent Application Publication
(10) Pub. No.: US 2014/0186596 A1
(43) Pub. Date: Jul. 3, 2014

(54) INK

(71) Applicant: Andy SHIPWAY, Jerusalem (IL)

(72) Inventor: Andy SHIPWAY, Jerusalem (IL)

(73) Assignee: DIP-TECH LTD., Kfar Saba (IL)

(21) Appl. No.: 14/138,790

(22) Filed: Dec. 23, 2013

Related U.S. Application Data
(60) Provisional application No. 61/746,627, filed on Dec. 28, 2012.

(51) Int. Cl. C09D 11/00

(52) U.S. Cl. CPC C09D 11/52
USPC 428/209; 252/514; 427/125

(57) ABSTRACT

A silver-based ink goes through several changes during the drying and firing process to change from a printable ink to a conductive silver film. The formulation of the ink is selected to optimize this process of changes and to produce a dense silver layer with adhesion to the substrate sufficient to prevent silver layer blistering and delamination.

### FIELD OF THE INVENTION

The method and the articles produced according to the method relate to the field of decorative and conductive ink deposition and curing on a glass or ceramic substrate.

### BACKGROUND OF THE INVENTION

Silver-based inks are popular for printing light-reflecting images and/or electrically conductive traces. The inks are widely used in production of hybrids, VLSIs, RFID patterns, antennas, heating elements, sensors, solar cells, and other electronic items where the inks are typically deposited by printing on ceramic materials. Such inks are also used in vehicular glass production where detailed circuit patterns, for example the defrost silver ink layer pattern of a back shield window of a car. Silver metal-based inks are also used for decorative purposes, for example, on glass substrates.

Existing silver inkjet inks are generally based on silver nanoparticles. These particles sinter at less than 300° C. to give a continuous silver film, on account of their nano-metric size which leads silver atoms on the highly curved nanoparticle surface to behave to some extent as a liquid and so effectively lowers the melting point of the nanostructured silver. A low sintering temperature is considered to be an advantage, as it saves time and energy and allows the use of e.g. plastic substrates. Therefore, much research effort has been expended to achieve silver nanoparticles and formulations thereof that provide sintering at especially low temperatures.

In order to ensure the optimum adhesion of the inks to certain substrates, in particular to glass or ceramic substrate, it can be advantageous to fire printed ink patterns at temperatures of about 600° C. This high-temperature treatment can provide a denser and more conductive silver layer even in the case of low-temperature-sintering particles. Heating above the Tg of the substrate (particularly relevant in the case of glasses) allows the more intimate contacting between the silver and the substrate, which in turn improves significantly the adhesion strength. In addition, silver ink may contain small amounts of a finely ground glass frit. The inclusion of such a frit is well-known in screen-printing pastes. The glass frit is added to improve the scratch-resistance and adhesion strength of a silver ink when it is fired above the Tg of the glass frit, typically to around 600° C. It should be noted that such screen-printing pastes utilize silver particles larger than 1 micron that do not sinter at a low temperature.

The thermo-mechanical conditions imposed during the firing of ink containing metal nanoparticles and the consequent formation of a continuous metal layer at a low temperature (e.g., 200° Celsius) on the glass or ceramic surface, develops in the metal layer a tensile stress. This stress is caused by the differential thermal expansion between the glass and the metal film/layer. (The thermal coefficient of expansion for silver is 18.9 ppm/° K and the thermal coefficient of expansion for soda-lime glass is ˜8.5 ppm/° K). This stress eventually causes the metal layer to peel off, form blisters, crack, or delaminate from the glass or ceramic substrate, thus limiting the useful output of the product or reducing useful product life.

The defects in the silver layer can occur rapidly and at a low temperature, and silver has a very high reflectivity in the infrared part of the electromagnetic spectrum. (The glass firing furnaces or kilns typically, utilize infrared (IR) heaters.) Thus when a printed object is fired aggressively to a high temperature, the continuous and inhomogeneous silver film causes differences in the heating rate of different parts of the substrate. These differences lead to stresses within the substrate itself, and consequently can result in warping, weakening, or even the catastrophic fracture of the entire item.

Although the cooling of the fired glass with a conductive silver film deposited on it can be a slower process that could continue for a couple of hours, it could also generate additional stress, because the metal layer could have segments not fully fired with the glass and the glass and the metal film all have different rates of cooling.

### SUMMARY OF THE INVENTION

The present method of forming a conductive silver film on a surface of a glass or ceramic substrate, which includes the deposition of an ink formulation onto the substrate, and thermal processing of the substrate with the deposited ink. In course of the thermal processing the continuous silver film is gradually generated from the silver compound or silver-based nanoparticles contained in the ink. As used in the present disclosure the term “silver-based nanoparticle” encompasses both silver metal and silver carbonate nanoparticles. As used in the current disclosure the term nanoparticle: includes particles having an average length of one dimension in the range of 1 to 100 nanometers.

The ink formulation comprises silver nanoparticles and a binder dispersed in a carrier. The binder is selected to coat the silver nanoparticles and keep the nanoparticles separated, thus, preventing the nanoparticles from sintering to form a continuous silver film until such time and temperature that the binder is thermally decomposed. The temperature is preferably close to the Tg of the substrate being coated by the ink formulation. A preferred binder coats the silver nanoparticles and thermally decomposes at a temperature of at least 300° C. so that the silver film is not formed on the substrate until a temperature of at least 300° C. is reached.

An example of a preferred ink composition comprises (All ingredients are provided by weight unless otherwise stated):

20% to 80% by weight of silver nanoparticles;

0.5% to 5% by weight of binder; and

the balance carrier, based on the total weight of the composition.

The composition can also contain, for example:

0.5% to 10% by weight of dispersant;

20% to 70% by weight of a solvent vehicle; and

0.05% to 2.0% of other additives.

Because the silver film is formed only at a temperature close to the Tg of the glass, heating is more homogeneous and strong adhesion is achieved rapidly upon film formation. In one example of the present ink, a silver film is produced only at about 300° C., and the differential thermal expansion by the time the maximum firing temperature is reached between the substrate, which could be glass, and the metal silver layer, is less than 0.1%. In another example of the present ink the silver film is produced even at higher temperatures of about 440-470° C., and the differential thermal expansion by the time the maximum firing temperature is reached, between the substrate and the metal silver layer, is almost negligible. At such small differential thermal expansion the bond of the metal silver layer shows substantially no blistering or delamination upon firing, and since strong and homogeneous adhesion is therefore achieved, the item does not suffer the problems described above upon fired glass cooling. In addition to the fabrication of conductive patterns with relatively large conductors, for example, vehicular glass, such method could be used to form detailed circuit patterns from metal silver on glass, ceramic or semiconductor substrates, and alleviate problems associated with metal layer blistering or delamination. The method and ink are also applicable to the production of decorative patterns and in particular for decorating construction glass that has to withstand harsh environmental conditions.

Additional features and advantages of the method will be apparent from the detailed description which follows, taken in conjunction with the accompanying data, which together illustrate, by way of example, features of the method.

### BRIEF DESCRIPTION OF THE DRAWINGS

FIG. 1 illustrates the TGA Results for Silver Carbonate.

FIG. 2 Illustrates the TGA Results for Disperbyk-106 Dispersant.

FIG. 3 illustrates the TGA Results for Paraloid B-66 Binder (A p(MMA-co-BA) acrylic resin.

FIG. 4 illustrates the TGA Results for Laropal A81 Binder.

FIG. 5 is a schematic illustration of an example of an article printed with the present ink.

### DETAILED DESCRIPTION OF THE INVENTION

The present ink could be deposited on the glass or ceramic substrate by screen printing or by inkjet printing. Described below are a number of ink compositions.

In one example of the ink, the silver is present in the form of silver carbonate particles. However, it is noted that silver carbonate exists in an equilibrium with silver oxide and carbon dioxide, so depending on the conditions and history of the ink or composition, a certain amount of silver oxide could also be present. Certain amounts of silver hydroxide and metallic silver could also be present in the ink. These silver compounds do not affect the ability of the ink to form conductive layers, even if they are present in large amounts. In concept the inks disclosed herein could be entirely based on silver oxide or silver hydroxide in place of silver carbonate, but silver oxide is a reactive material that is unstable towards easily oxidized materials, atmospheric carbon dioxide, and light—and silver hydroxide is also relatively unstable and difficult to prepare.

In another example of the ink, the silver is present in the form of silver metal nanoparticles. In this case, a binder is additionally present in the formulation, which coats the silver nanoparticles and keeps them separate, thus preventing them from sintering to form a continuous film until such time and temperature that the binder is thermally decomposed.

The carrier in which the silver nanoparticles are dispersed can be any desired carrier. Examples of suitable carriers comprise solvents (also referred to as a solvent vehicle) which evaporate or decompose at a temperature below the thermal decomposition temperature of the binder.

Following ink deposition, the ink composition is dried to evaporate or decompose the solvent vehicle to provide the substrate with a deposited pattern. The substrate is subjected to a heat treatment is usually performed at 20° Celsius to 700° Celsius. This temperature range provides the metal silver layer with desired physical properties. The heat treatment could be performed under inert gas atmosphere, or in air, nitrogen or carbon monoxide or in a mixture gas comprising hydrogen and air or other inert gas, depending on the need. The different ingredients of the ink decompose at different temperatures and rates, but in general the order of processes is as shown in Table 1. It should be noted that these values were measured specifically under conditions similar to commercial glass firing at a heating rate of 50° K/min and an air atmosphere. Literature values for the processes may be different. For example, 280° C. is often quoted as a temperature for the spontaneous reduction of silver oxide.

TABLE 1
Ink Ingredients Decomposition Schedule

| Process Temperature | Process description |
|---|---|
| 20-40° Celsius | Temperature at which the printing is |
| | performed |
| 50-200° Celsius | Evaporation of solvents (vehicle) to give dry |
| | ink layer |
| 200-300° Celsius | Decarboxylation of silver carbonate to give |
| | silver oxide |
| 250-400° Celsius | Decomposition of organic materials (e.g. |
| | dispersants, binders) |
| 440-470° Celsius | Decomposition of silver oxide to give silver |
| | metal |
| 570° Celsius | Tg of soda-lime (substrate) glass. |
| 670° Celsius | Maximum firing temperature. |

At a temperature of about 220° Celsius, silver carbonate decarboxylates releasing carbon dioxide (CO₂) to give silver oxide. It further undergoes spontaneous reduction at temperatures exceeding 280° Celsius, to release oxygen and yield silver metal. At temperatures between approximately 200 and 350° Celsius, organic materials are decomposed and/or oxidized. The decomposition of the organic components takes place partly by oxidation (by atmospheric oxygen), and in some cases can leave a carbon-rich residue that does not further decompose during the firing process. Such carbon residue is electrically conductive, so it does not impact the electric properties of the ink. While silver carbonate is an electrical insulator, silver oxide is a semiconductor (resistivity of about ˜10,000 Ωm) and silver metal is a conductor (resistivity ˜16 Ωm).

The silver carbonate into metal silver conversion stages as well as other ink ingredients dynamics has been experimentally measured. The ink ingredients were submitted to TGA/DSC (thermo-gravimetric (TGA) and differential scanning calorimetric (DSC)) analyses to determine how they decompose under glass firing conditions. In order to as closely as possible model the firing process, the TGA runs were made under air at a heating rate of 50° K/min.

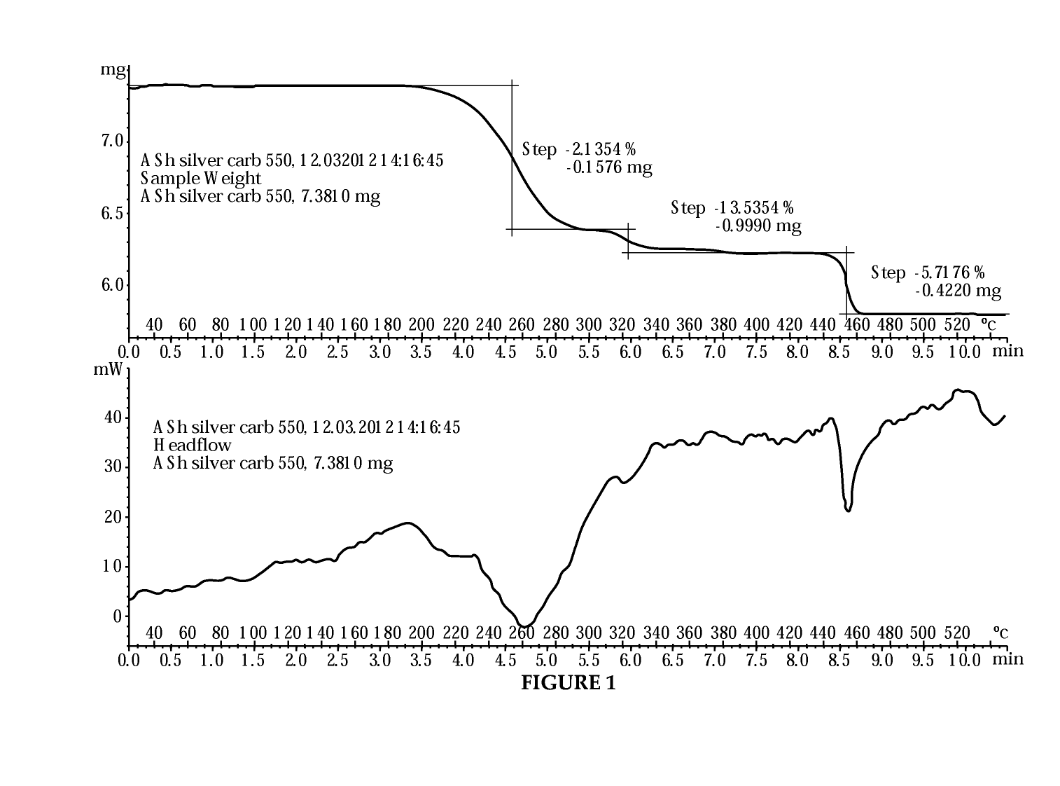

The TGA Results for Silver Carbonate is shown in FIG. 1.

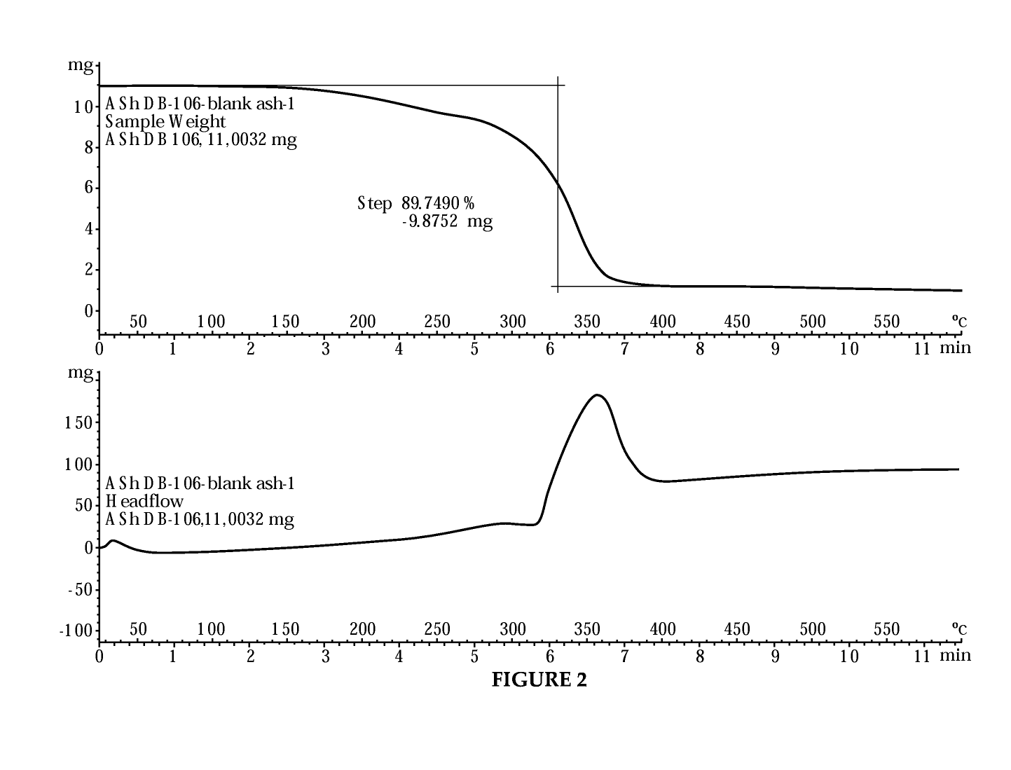

The TGA Results for Disperbyk-106 Dispersant is shown in FIG. 2. (Disperbyk™-106 is an acidic dispersant commercially available from Byk Chemie of Wesel, Germany.)

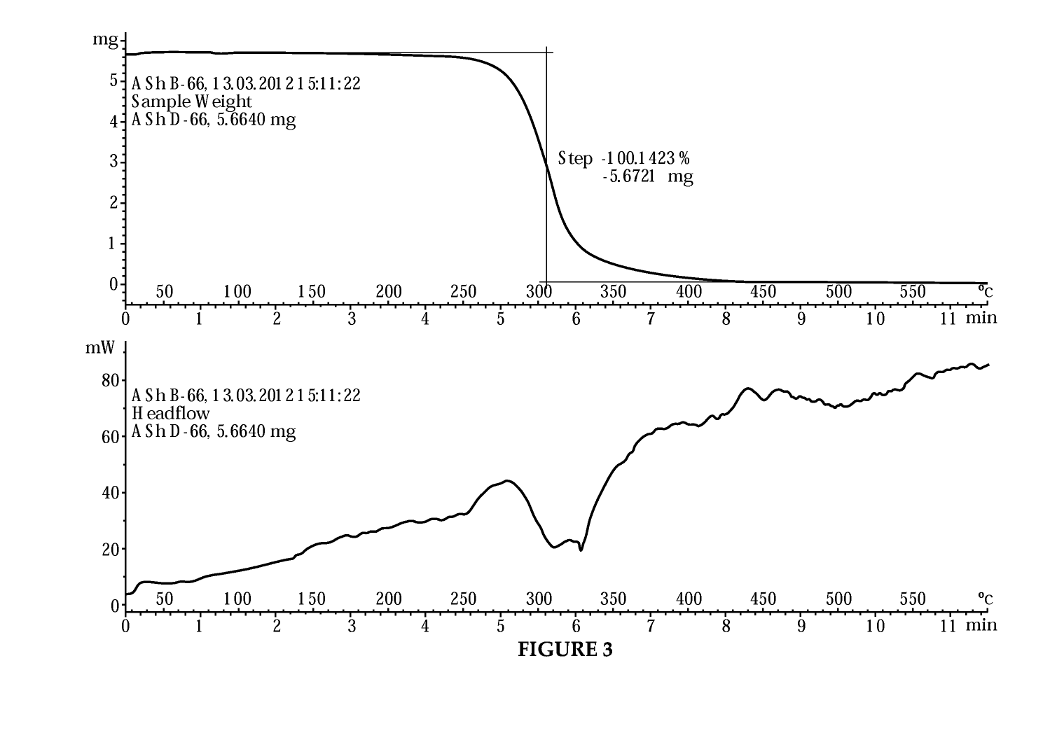

The TGA Results for Paraloid B-66 Binder (A p(MMA-co-BA) acrylic resin available from the Dow chemical company) is shown in FIG. 3.

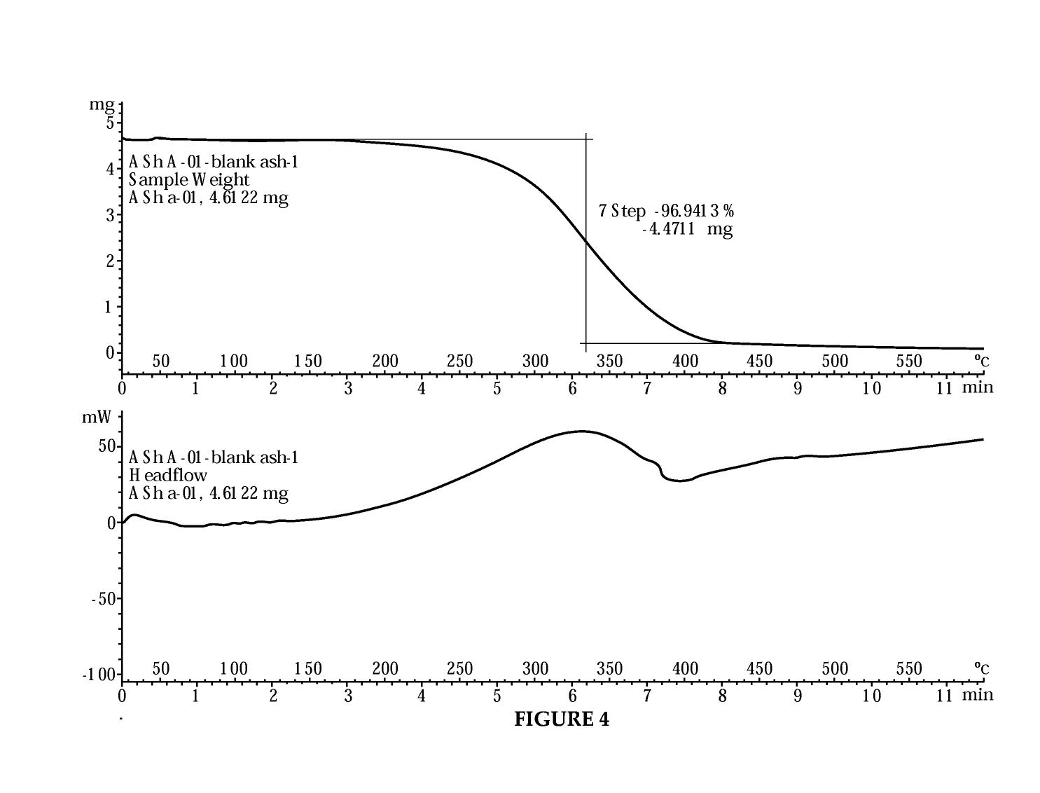

The TGA Results for Laropal A81 Binder (Laropal A81 Binder is an aldehyde resin commercially available from BASF Aktiengesellschaft, 67056 Ludwigshafen Germany) is shown in FIG. 4.

The dispersant and the binder are organic components of the ink composition. These are the components that control the morphology of the dried ink, coating the individual inorganic particles and holding them into a specific matrix. It can be seen from the TGA analyses that the dispersant (Disperbyk DB-106) and Binder (Laropal A81) that produce a silver carbonate-based ink with good adhesion to the substrate, decompose at temperatures intermediate between the two decomposition regions of the silver carbonate (at 260-400° Celsius). Without being bound by a specific theory, the author believes that better adhesion of the final metal silver results from inks where the silver carbonate particles continue to be stabilized during their decarboxylation. Accordingly, the binders and dispersants for silver carbonate-based inks were selected from compounds that have decomposition temperatures (peak center, measured by TGA under air at 50° K/min) above 315° C.

In contrast, the dispersant (stearic acid) that produces silver carbonate-based inks with poor adhesion to the substrate, begins to decompose well before the decarboxylation of the silver carbonate is complete.

In the case of silver nanoparticle-based inks, the binder could be chosen to provide isolation of the nanoparticles from each other until a high temperature. Therefore, in order to have a positive effect, the decomposition temperature of the binder is selected to be higher than the natural sintering temperature of the silver particles. Both A-81 and B-66 decompose above 300 C—higher than the sintering temperature of silver nanoparticles—and can effectively prevent low-temperature sintering of silver nanoparticles. If a large quantity of binder is used, then its large volume fraction in the dry pre-fired ink layer results in a porous and semitransparent silver layer. Typically this effect can occur at around 15 volume % or more. All volume % are based on the total volume of the composition unless otherwise stated. In some cases this semitransparency may be an advantageous feature, particularly since the semitransparent silver layer retains conductivity.

Glass firing furnaces typically utilize infrared (IR) heaters. When conventional ink containing metal silver particles is sintered, the metal silver reflects IR radiation, and so the glass heats slowly and inhomogeneously, i.e., the areas and side with metal silver coating i.e., the areas with metal silver coating heat slower, particularly if blisters are present. These areas heat and cool more slowly than uncovered by metal silver areas. Consequently time and energy consumption to perform proper heat treatment can be increased, and stresses occur in the glass that leads to spontaneous breakage or deformation of the metal silver layer and in some cases of the glass substrate also.

According to the present method and ink composition used, decomposition of silver oxide to give silver metal layer takes place at temperatures of about 440-470° Celsius or even higher temperatures, and decomposition of binders to allow nanoparticle sintering occurs above 300° Celsius. Ink components present on the surface of the glass reflect IR to a much lesser extent and the heating of the glass substrate and of the ink layer is homogenous and does not form tensile stress between the ink layer and the glass substrate. This removes an additional potential source of metal silver layer blisters and delamination formation.

Ink Composition Ingredients Selection

Ink-jet inks are commonly formulated to contain a large proportion of a mobile liquid vehicle. The current inkjet ink compositions could contain organic compounds (vehicle) such as for example, Dipropylene Glycol Monomethyl Ether (DPM). The organic compounds could evaporate, decompose or even burn out at certain temperatures, preferably below the decomposition temperature of the binder.

The liquid vehicle is selected for properties including its viscosity, safety, chemical stability, cost, and vapor pressure. The vehicle is also selected not to allow the ink to dry in the inkjet print-heads to such an extent that the heads become clogged. The liquid vehicle could be a mixture of components.

Vehicle components could include glycol ethers, alcohols (including diols) and their esters of varying lengths, for example as marketed under the Dowanol trade name by The Dow Chemical Company, Midland, Mich. 48642 U.S.A. Other components may include ketones such as cyclohexanone, organic carbonates, diesters of dicarboxylic acids, water, alkanes, oils, and paraffins.

Silver carbonate is less dense than silver metal, but is still a dense material with specific weight of about 5.5 g/cm3, so it could be difficult to stabilize it in a dispersion. It contains 78% silver by mass. At the same time, high solids dispersion will make a high density ink, which may be problematic.

The vehicle is evaporated at a temperature lower than that which will chemically alter the other organic components or the silver carbonate, and this evaporation takes place in a “drying” step prior to the higher temperature treatment ‘firing” of the ink layer. Most of the dispersants examined for silver carbonate were acidic polymers or salts of acidic polymers, because of their ability to bind (and even react with) the silver carbonate particle surface. Acidic dispersants such as Disperbyk™-106 (DB-106) (Disperbyk is a trademark of Byk Chemie of Wesel, Germany) were found to give dispersions that settled more slowly than acid salt dispersants. For example, Disperbyk™-106 (DB-106) was superior to Disperbyk™-180 (DB-180) both in speed of settling and in re-dispersibility. Stearic acid (CH3(CH2)16CO2H) gave the most stable dispersion and was easier than the other acid dispersants to redisperse after settling for a short period.

Silver nanoparticle dispersions were used as supplied either by the Hebrew University of Jerusalem (Magdassi group) or XJet Solar (Rehovot, Israel). These dispersions are of proprietary composition and include dispersants.

In order to provide the final ink layer with high adhesivity to the substrate and high scratch-resistance, glass frit or other inorganic fillers could be included in the ink composition. Such a frit could melt below the processing temperature of the ink. A bismuth-based glass frit was found to significantly increase the adhesivity of silver formed from silver carbonate in the case where the formulation otherwise provided poor adhesivity. This improvement was noted at a 0.5% to 10% concentration of glass frit, but at higher levels of glass frit concentration (above 5 wt %) the resistivity of the resulting silver layer was also increased.

To provide an ink with appropriate physical properties for inkjet printing onto glass, the hydrophobicity and surface tension of the ink must be appropriate. Certain additives designed to control these properties are therefore added to the ink composition. Additional materials may be added to improve leveling behavior. Many additives are available from various suppliers to perform these tasks. Specifically, Byk-341 can be used with silver carbonate-based inks to reduce surface tension, and Byk-358 both available from BYK-Chemie GmbHBYK-Chemie GmbH, Germany can be used to improve leveling behavior.

After printing and prior to the heat treatment (firing), a lower temperature “drying” step is performed. This removes the majority of the liquid vehicle, preparing the ink layer for firing, and leaves the ink layer robust and dry enough for required handling (“green” layer). In order to maximize this robustness, a binder may be included in the ink composition in a low concentration. As with the other organic components of the ink, its selection could be made carefully in order to ensure that the properties of the fired ink will be optimal.

At a concentration of 2%, the aldehyde resin Laropal A-81 commercially available from BASF Aktiengesellschaft, Germany provides a “green” scratch resistance close to 8B (suitable for the required handling) without causing a large increase in viscosity of the ink. PVP (polyvinylpyyrolidone, MW 10,000) gave similar results. PVB (polyvinyl butyral) and methyl cellulose binders give less impressive scratch resistance of the unfired, dried layer. However, all these four binders provide inks that result in a high adhesion of the final silver layer to the glass. In contrast, the acrylic binder Paraloid B-66 commercially available from Rohm and Haas, USA, commonly used in this kind of ink, provides an ink that results in poor adhesion of the silver layer to the glass after firing when used in formulations with silver carbonate.

The physical properties of the inks were measured using the following techniques: Testing of the adhesion of the fired silver ink layer to the substrate was performed by rubbing the layer with a small (˜2 cm2) wad of steel wool at least 20 times in a circular motion with a load of approximately 300 g.

The reflectance of fired and polished silver layers obtained with different ink formulations was measured at different incident angles using red HeNe laser (Wavelength 632nm.). The measured reflectance was higher than 90%.

### EXAMPLES

The following ink compositions represent examples of the present ink. They are presented to explain the compositions in more detail, and do not limit the ink to the presented compositions. Some comparative ink examples of known standard silver nanoparticle-based inks have been given to demonstrate the differences in their blistering behavior.

### COMPARATIVE INK EXAMPLES

### Standard Silver Nanoparticle-Based Inkjet Inks

A silver nanoparticle-based ink (50 wt % silver in Dowanol DB) was purchased from the Hebrew University of Jerusalem. Another silver nanoparticle-based ink (50 wt %) was purchased from PV Nano Cell Ltd. Migdal Ha'Emek, 23100 Israel. A third nanoparticle-based ink was created by diluting commercial silver nanoparticle dispersion from XJet Solar Rehovot 76701, Israel with Dowanol DPM to achieve a dispersion containing 45 wt % silver. All of these inks were designed for inkjet printing, and were printed successfully by this method on glass.

All samples printed with these inks dried at 120° C. to give dark-colored reflective films. All three commercial inks sintered to give continuous conductive silver films at temperatures of less than 250 C. However, such films had very poor adhesion to the glass substrate. Upon firing to glass processing temperatures (670° C.), all samples fractured violently into many pieces. Examination of the samples after cooling showed that although some parts still had reasonable adhesion strength, all samples contained large amounts of blistering where the silver film was entirely detached from the glass surface.

### Example 1

### Nanoparticle-Based Inkjet Ink Modified with A-81 Binder

An ink was made by formulating:

| Ingredient | Percentage |
|---|---|
| Silver nanoparticle dispersion (65% silver in | 70% |
| DPM, available from XJet Solar) | |
| 20% solution of A81 binder in DPM | 20% |
| 70% dispersion of glass frit in DPM | 3% |
| Disperbyk-180 | 1% |
| DPM | 6% |

Additives, dispersants, and other ink ingredients could be added when necessary. [All amounts are given by weight unless otherwise noted.]

The ink produced had a viscosity of 23.7 cP at 25 C. (Viscosity was measured using a Brookfield DV1 low-viscosity viscometer running at 80 rpm at 25° C. with spindle 18.) The ink was printed by inkjet printing using Dimatix-Spectra inkjet printhead commercially available from FujiFilm, Inc., New Hampshire USA to give a print that dried to give a matte blue appearance. After firing at 670° C., the print had a scratch resistance in excess of 30N and gave a resistivity estimated at about twice (˜2×) the resisitivity of bulk silver. No blisters or serious defects were noted. (Scratch testing was performed using an Elcometer 3092 sclerometer available from Elcometer Limited, Manchester UK set at 20N (Blue spring) or 30N (Green spring) force. The sample was considered to “pass” in the case that the sclerometer did not remove silver from the substrate (i.e. did not scratch all the way through the silver layer), even if the surface was marked.)

An analogous formulation with half the quantity of A81 gave a print that fired to give blisters and cracking of the glass.

### Example 2

### Nanoparticle-Based Inkjet Ink Modified with B-66 Binder

An ink was made by formulating:

| Ingredient | Percentage |
|---|---|
| Silver nanoparticle dispersion (65% silver in | 70% |
| DPM, available from XJet Solar) | |
| 10% solution of Paraloid B66* binder in | 12% |
| Dowanol PGDA | |
| Dowanol PGDA** | 18% |

*PARALOID B-66 is a thermoplastic acrylic resin commercially available from Dow Chemical Company, Midland, Michigan 48642 U.S.A.
**DOWANOL ™ PGDA is a Glycol Ether commercially available from Dow Chemical Company, Midland, Michigan 48642 U.S.A.

The ink produced had a viscosity of 17 cP at 25 C, a surface tension of 25 dyne/cm, and a density of 1.63 g/cc. It was printed by inkjet printing using Dimatix-Spectra printheads to give a print that dried to give a matte blue appearance. After firing at 670° C., the print had a scratch resistance in excess of 20N (Tested by an Elcometer 3092 (Blue spring)) and gave a resistivity estimated at about twice (˜2×) the resisitivity of bulk silver. No blisters or serious defects were noted.

An analogous formulation with 10% of the B66 solution gave a print that fired to give blisters and cracking of the glass. An analogous formulation with 20% of the B66 solution gave a fired sample that had a much whiter appearance and some transparency.

### Example 3

### Silver Carbonate-Based Ink

8.25 g of finely ground silver carbonate powder (available from Aldrich Chemical Company, Milwaukee, Wis. USA) and 3.48 g of DPM were sonicated and shaken together for 10 minutes. The result was a slurry containing 70% silver carbonate (w/w). When the dispersant DB-106 was added to this mixture at a concentration of about 5% w/w, it resulted in an ink that gave excellent homogeneous film-forming ability. The samples were fired at a temperature of about 650° Celsius for a time of approximately 2 minutes. This firing time was sufficient to change at least the conductivity of the layer of ink making it higher than the green layer conductivity. The resistivity of the layer of ink of metal silver was less than ten times the resistivity of bulk silver metal. The electrical resistance of fired silver layers obtained with different ink formulations was tested with a simple two-probe digital multimeter. The probes were pressed onto the sample surface at a separation of about 5 cm. Readings of 1.5 Ohm or less were considered to be a “pass” as this represents approximately the contact resistance of the probes with the surface.

After firing the samples had a white or off-white surface color and were dispersing incident light (i.e. had matte appearance). This is likely micro or nano-structured silver, as is also observed when objects are electroplated with silver. After being polished, this white surface revealed a shiny highly light-reflecting silver surface. The polishing medium was a slurry prepared from submicron glass frit with Disperbyk-180 in a mixture of DPM and water.

This ink passed the adhesion, 20N sclerometer force scratch, and conductivity tests described above.

### Example 4

### Silver Carbonate-Based Ink

This is a high-adhesion ink composition prepared by using 2.7 g of the slurry described in Example 3, mixed with 1.42 g of a 10% solution of DB-106 in DPM, to achieve an ink containing 46% w/w solids (about 36% w/w metal silver). This ink is stable for a limited period, but is easily redispersible. The ink composition was drawn at different thicknesses on a glass substrate it formed a silver layer that after firing could not be easily removed even by rubbing with metallic mesh scourer, although the applied layer was relatively a thin 24 microns layer. The layer passed the scratch test at 30N, as well as the adhesion test and the conductivity test. The resistivity of the layer of ink of metal silver was less than ten times the resistivity of bulk silver metal.

The ink and the method described could find use for inkjet printing on glass, specifically to achieve conductivity, and more specifically to allow the printing of rear-window demisters for the automotive industry. However, other applications for conductive printing on glass exist, such as RFID tags, GPS and radio antennas, sensors, power transfer in lighting, etc.

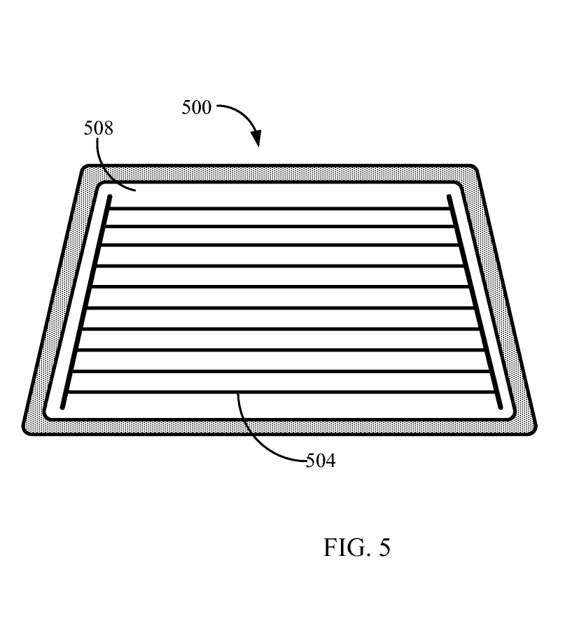

FIG. 5 is a schematic illustration of an example of an article 500, which is a rear-window of a car with a demister, printed or deposited using the disclosed ink. The demister pattern 504 is printed on glass substrate 508. The metallic coating or ink of pattern 504 possess a coefficient of thermal expansion at least twice as large as the coefficient of thermal expansion of the glass substrate 508. Following a thermal processing including firing of the metallic coating of pattern 504 and the substrate, the article was subject to multiple tests that included multiple defrost processes. The article exhibited no delamination or blistering of the metallic coating of pattern 504 relative to the underlying substrate 508.

In addition, polishing the deposited and fired layer results in a shiny silver surface that has applications for decoration. Thin semitransparent silver layers could be used for IR-reflectance in semitransparent windows, i.e. for “cool window” applications.

The technology does not need to be limited to silver—other noble metals could be processed in an analogous way, for example using gold(I)chloride (decomposes to form gold metal at 298° Celsius), or platinum(II)chloride (decomposes to give platinum metal), or palladium acetate or palladium(II)chloride (decompose to give palladium metal). Osmium(IV) compounds such as the oxide and chloride could similarly decompose to form osmium metal. The substrate also does not need to be limited to glass, and can be extended to metals and ceramic substrates (that can survive the high-temperature firing). Finally, the process methodology does not need to be limited to inkjet printing, since it is relevant to e.g. screen-printing, flexographic printing, roller-coating and even hand-painting.

In the decorative arena, an ink could have additional components. For example, and ink which contains silver carbonate together with other pigments could be used to achieve e.g. iridescent or metallic effects.

While the method of forming a conductive and decorative substrate coating has been described in conjunction with the specific examples outlined above, it is evident that many alternatives, modifications and variations will be apparent to those skilled in the art. Accordingly, the examples as set forth above are intended to be illustrative, not limiting. Various changes may be made without departing from the spirit and scope of the examples as defined in the following claims.

What is claimed is:

1. An ink for printing reflective or conductive layers on a glass substrate comprising:
silver nanoparticles;
a binder selected to prevent sintering of the silver nanoparticles until at least a temperature of 300° Celsius; and
a carrier, wherein the composition is in the form of a dispersion with the silver nanoparticles dispersed in the carrier.

2. The ink according to claim 1, wherein the carrier comprises Dipropylene Glycol Monomethyl Ether (DPM).

3. The ink according to claim 1, wherein the binder in the ink is at least 0.5% by weight based on the total weight of the composition.

4. The ink according to claim 1, wherein the differential thermal expansion by the time the maximum firing temperature (670° Celsius) is reached between the glass substrate and the metal silver film produced at a temperature of at least 300° Celsius is less than 0.1% and wherein the differential thermal expansion between the glass substrate and the metal silver film is small enough to avoid silver film blisters formation.

5. The ink according to claim 1, wherein the binder comprises at least one of selected from the group of binders consisting of aldehyde resin Laropal A81 binder and acrylic resin Paraloid B66 binder.

6. The ink according to claim 2, wherein the silver nanoparticles dispersion is a 65% silver nanoparticles dispersion in DPM and amount of the nanoparticles dispersion in the ink is 70%.

7. The ink according to claim 1, wherein the carrier comprises a dispersant Disperbyk ˜180 and amount of the dispersant in the ink is up to 1% by weight based on the total weight of the composition.

8. The ink according to claim 1, wherein the composition further comprises a bismuth-based glass frit in an amount of at least 0.5% by weight based on the total weight of the composition.

9. An ink for printing reflective and conductive layers on a glass substrate comprising:
a silver compound slurry in dipropylene glycol monomethyl ether (DPM);
a glass frit dispersion in DPM;
a dispersant; and
wherein the silver compound is converted into metallic silver film and wherein conversion of the silver compound into metallic silver film is produced at temperatures between 440-470° Celsius.

10. The ink according to claim 9 wherein the differential thermal expansion by the time the maximum firing temperature (670° Celsius) is reached between the glass substrate and the metallic silver film produced at temperatures between 440-470° Celsius is negligible.

11. The ink according to claim 9 wherein the differential thermal expansion by the time the maximum firing temperature (670° Celsius) is reached between the glass substrate and the metal silver film produced at a temperatures between 440-470° Celsius is negligible and wherein the differential thermal expansion between the glass substrate and the metallic silver film is small enough to avoid silver film blisters formation.

12. The ink according to claim 9 wherein the silver compound includes at least one of silver carbonate, silver oxide and carbon dioxide, silver hydroxide and metallic silver.

13. The ink according to claim 9 wherein the silver compound comprises a slurry containing 70% of silver carbonate particles.

14. The ink according to claim 9 wherein the glass frit is a bismuth-based glass frit and wherein the ink contains at least 0.5% of glass frit.

15. The ink according to claim 9 wherein the silver compound into metallic silver conversion includes:
decarboxylation of silver carbonate to give silver oxide at a temperature of about 300° Celsius; and
decomposition of silver oxide to give silver metal at temperatures of 440-470° Celsius.

16. An ink composition comprising:
20% to 80% of silver carbonate
0.5% to 10% of dispersant;
20% to 70% of vehicle;
0.5% to 5% of binder; and
0.05% to 2.0% of other additives.

17. A method for printing reflective and conductive layers on a glass substrate comprising:
printing an ink on a glass substrate to form an ink pattern on the substrate, the ink comprising at least at least one silver compound and a binder selected to provide isolation of silver nanoparticles of the silver compound from each other until at least a temperature of 300° Celsius; and
thermally processing the glass substrate with the ink pattern at a temperature and time sufficient to convert the silver compound into metal silver, wherein the silver compound in course of process of being converted into metal silver undergoes a number of transformations with the last transformation being metal silver and wherein the transformation to continuous metal silver layer takes place at a temperature of at least 300° Celsius.

18. The method according to claim 17 wherein the silver compound comprises nanoparticle metallic silver and a binder is present that prevents the nanoparticle metallic silver sintering below 300° C.

19. The method according to claim 17 wherein the silver compound comprises silver carbonate.

20. The method according to claim 17 wherein thermal processing of the article includes firing the metal silver into the substrate surface.

21. The method according to claim 17 wherein the metallic silver is produced at firing temperature of at least 440° Celsius.

22. The method according to claim 17 wherein the silver compound transformation into metallic silver changes conductivity of the layer of ink.

46. The method according to claim 17 wherein the glass firing takes place in furnaces utilizing infrared (IR) heaters and ink components present on the surface of the glass reflect IR to a much lesser extent and the heating of the glass substrate and of the ink layer is homogenous and does not form tensile stress between the metal silver layer and the glass substrate avoiding blisters and delamination formation.

23. The method according to claim 17 wherein resistivity of the layer of ink of metal silver is less than ten times the resistivity of bulk silver metal.

24. The method according to claim 17 wherein the layer of metal silver after firing has a light dispersing (i.e. diffusive, matte) surface.

25. The method according to claim 17 further comprising polishing the layer of metal silver after firing to produce a reflective silver layer surface.

26. The method according to claim 25 wherein the reflectance of the reflective silver layer surface is at least 90% at a wavelength of 632nm.

27. The method according to claim 17 further comprising drying the layer of ink containing at least silver carbonate particles prior to firing and the drying removes volatile organic components, reducing the content of organic materials from more than 40% to less than 20%.

28. An article comprising:
a substrate with a metallic coating possessing a coefficient of thermal expansion at least twice as large as the coefficient of thermal expansion of the substrate, wherein the article exhibits no delamination or blistering of the coating relative to the underlying substrate after the article has been exposed to a thermal processing including firing of the metallic coating to the substrate.
